(19) United States
(12) Patent Application Publication
(10) Pub. No.: US 2014/0250032 A1
(43) Pub. Date: Sep. 4, 2014

(54) METHODS, SYSTEMS AND PROCESSOR-READABLE MEDIA FOR SIMULTANEOUS SENTIMENT ANALYSIS AND TOPIC CLASSIFICATION WITH MULTIPLE LABELS

(71) Applicant: XEROX CORPORATION, Norwalk, CT (US)

(72) Inventors: Shu Huang, State College, PA (US); Wei Peng, Sunnyvale, CA (US); Jingxuan Li, Miami, FL (US)

(73) Assignee: Xerox Corporation, Norwalk, CT (US)

(21) Appl. No.: 13/782,463

(22) Filed: Mar. 1, 2013

(51) Int. Cl. G06N 99/00

(52) U.S. Cl. CPC G06N 99/005
USPC 706/12

(57) ABSTRACT

Methods, systems and processor-readable media for simultaneous sentiment analysis and topic classification with multiple labels. A sentiment and topic associated with a post can be classified at similar time and a result can be incorporated to predict a feature so that a label of two (or more) tasks can promote and reinforce each other iteratively. A feature extraction and selection can be performed on the tasks and a multi-task multi-label classification model can be trained for each task with maximum entropy utilizing multiple labels to ascertain information derived from an extra label and to manage class ambiguities. Each task has a separate classification model with different predicting features and they can be trained collectively which allows flexibility in model construction. The multi-task multi-label classification model produces a probabilistic result and the classes can be ranked by the probabilistic result and the post can be classified with the multi-label.

### FIELD OF THE INVENTION

Embodiments are generally related to sentiment analysis and topic classification systems and methods. Embodiments are also related to multi-task and multi-label classification methods. Embodiments are additionally related to system and method for simultaneous sentiment analysis and topic classification with multiple labels.

### BACKGROUND

Sentiment and topic analysis have a wide application in business marketing and customer care applications to assist in evaluating and understanding brand perception and customer requirements based on, for example, data gathered from millions of online posts such as social media, forums, and blogs. For example, when promoting a new policy/product, a company may monitor electronically posted customer comments regarding a particular policy/product so that the company can respond properly and address criticisms and issues in a timely manner. Hence, online monitoring of current sentiment trend and topics related to, for example, a preset product and brand name is important for modern marketing.

Prior art approaches to sentiment and topic analysis are manually performed as two separate tasks. Manual techniques for sentiment and topic analysis are costly, time consuming, and error prone. Additionally, posts regarding particular topics have a high probability of presenting certain sentiment and similar words may have different meanings or sentiment in different topics.

Another problem associated with prior art sentiment analysis and topic classification approaches is that each post is usually assigned to only one sentiment label and one topic class label for training. Sentiment analysis, however, is very subjective, thus different annotators may interpret sentiment differently. Also, a single post may belong to multiple topics. Furthermore, in the process of acquiring training and testing data for these two tasks, several annotators can usually label the same set of posts.

Crowd-sourcing platforms have been employed to obtain multiple human labels for each post effectively from millions of workers online. To resolve the disagreement between different annotators, researchers usually obtain the final labels based on a voting majority. The problem with such a voting approach is that useful posts and labels may be discarded if they do not match the majority labels.

Based on the foregoing, it is believed that a need exists for improved methods and systems for simultaneous sentiment analysis and topic classification with multiple labels, as will be described in greater detail herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved sentiment analysis and topic classification methods, systems and processor-readable media.

It is another aspect of the disclosed embodiments to provide for an improved multi-task and multi-label classification algorithm.

It is a further aspect of the disclosed embodiments to provide for improved methods, systems and processor-readable media for simultaneous sentiment analysis and topic classification with multiple labels.

The aforementioned aspects and other objectives and advantages can now be achieved as described herein. Methods, systems and processor-readable media for simultaneous sentiment analysis and topic classification with multiple labels are disclosed herein. A sentiment and topic associated with a post can be classified at similar time and a result can be incorporated to predict a feature so that a label of two tasks can promote and reinforce each other iteratively. A feature extraction and selection can be performed on both tasks of sentiment and topic classification. A multi-task multi-label classification model can be trained for each task with maximum entropy utilizing multiple labels to ascertain data indicative of and/or derived from an extra label and to manage with class ambiguities. Each task has a separate classification model with different predicting features and they can be trained collectively which allows flexibility in model construction. Such multi-task multi-label (MTML) classification model produces a probabilistic result and the classes can be ranked by the probabilistic result and the post can be classified with the multi-label.

A stopping word can be removed and a meaningful keyword and bi-gram can be extracted for a collection of messages. Thereafter, different numbers of predicting features can be chosen from the keyword and bi-gram. Then the model can be trained with the predicting features and the accuracy can be evaluated accordingly. Finally, the number of predicting features can be determined. For each task, predicting features can be selected independently from other tasks. The labels of one task can be integrated as predicting variables into a feature vector of another task. A coefficient can be estimated utilizing multi-task KL-divergence based on prior distribution of the labels to incorporate multi-label. The maximum entropy based multi-task classification model can be employed to simulate the distribution of both sentiment and topic classes. Such an approach permits flexible multi-label classification in multiple tasks as predicting labels are associated with weights.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system, in accordance with the disclosed embodiments;

FIG. 2 illustrates a schematic view of a software system including a sentiment analysis and topic classification module, an operating system, and a user interface, in accordance with the disclosed embodiments;

FIG. 3 illustrates a block diagram of a sentiment analysis and topic classification system, in accordance with the disclosed embodiments;

FIG. 4 illustrates a high level flow chart of operations illustrating logical operational steps of a method for simultaneous sentiment analysis and topic classification with multiple labels, in accordance with the disclosed embodiments.

FIGS. 5-6 illustrate a graph depicting distribution of sentimental classes and topic classes, in accordance with the disclosed embodiments; and

FIGS. 7-8 illustrate a graph depicting distribution of sentiment and topic classification accuracy of multi-task multi-label model and baselines, in accordance with the disclosed embodiments.

### DETAILED DESCRIPTION

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one skilled in the art, the present invention can be embodied as a method, data processing system, or computer program product. Accordingly, the present invention may take the form of an entire hardware embodiment, an entire software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Although not required, the disclosed embodiments will be described in the general context of computer-executable instructions such as program modules being executed by a single computer. In most instances, a “module” constitutes a software application. Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

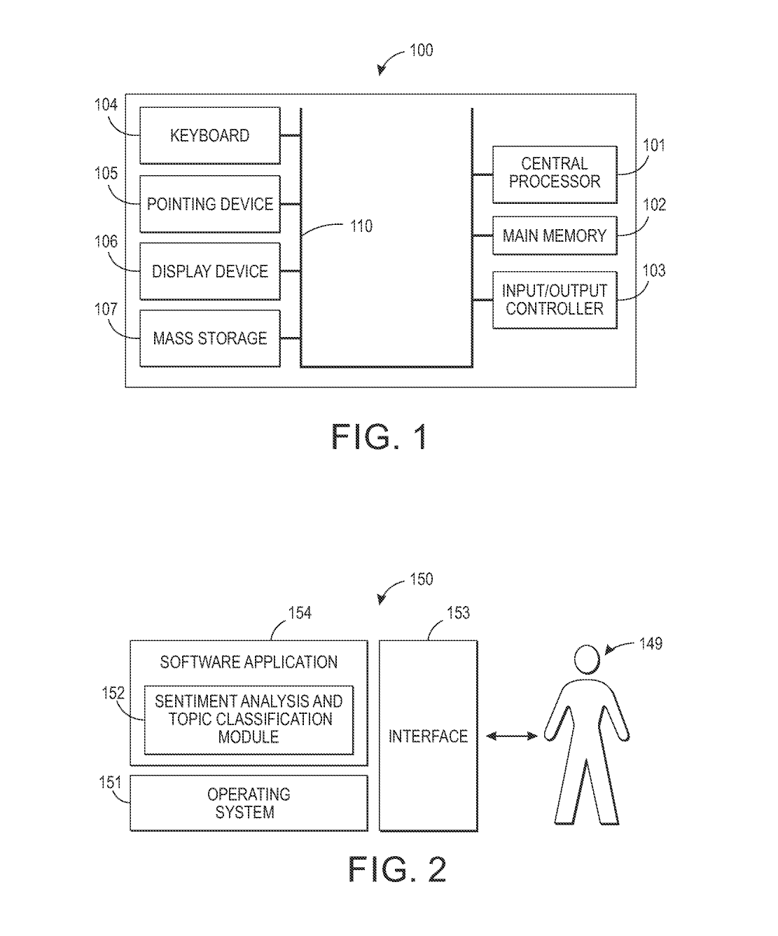

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 that includes, for example, a central processor 101, a main memory 102, an input/output controller 103, a keyboard 104, an input device 105 (e.g., a pointing device such as a mouse, track ball, and pen device, etc.), a display device 106, a mass storage 107 (e.g., a hard disk), and a USB (Universal Serial Bus) peripheral connection. As illustrated, the various components of data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153 from a user 149; these inputs may then be acted upon by the data-processing system 100 in accordance with instructions from operating system module 152 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application such as a computer program designed to assist in the performance of a specific task such as word processing, accounting, inventory management, etc.

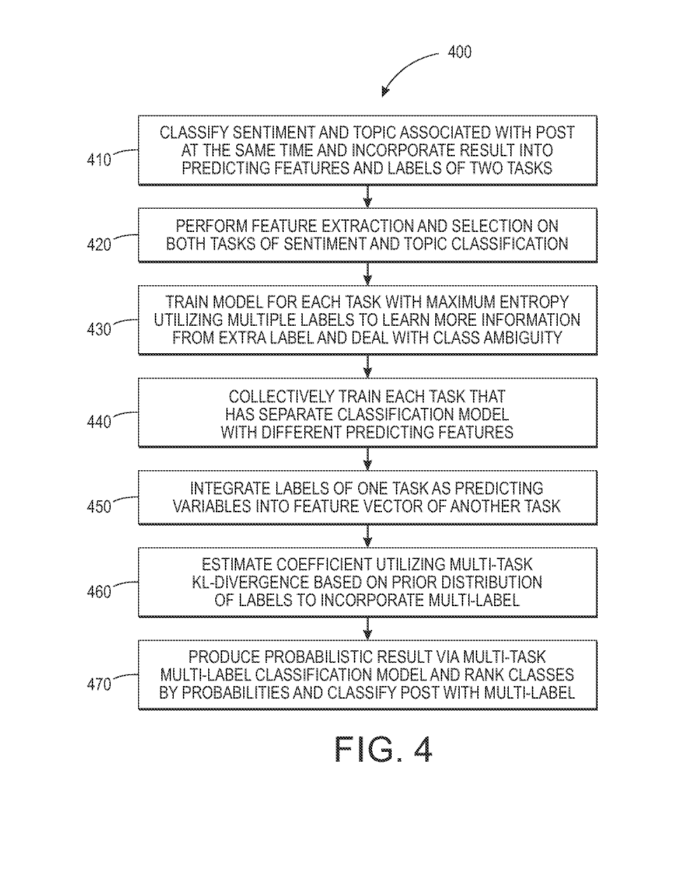

The interface 153, which is preferably a graphical user interface (GUI), also serves to display results, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 154 can include a sentiment analysis and topic classification module 152 for simultaneous sentiment analysis and topic classification with multiple labels. Software application 154, on the other hand, can include instructions such as the various operations described herein with respect to the various components and modules described herein such as, for example, the method 400 depicted in FIG. 4.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, and the like.

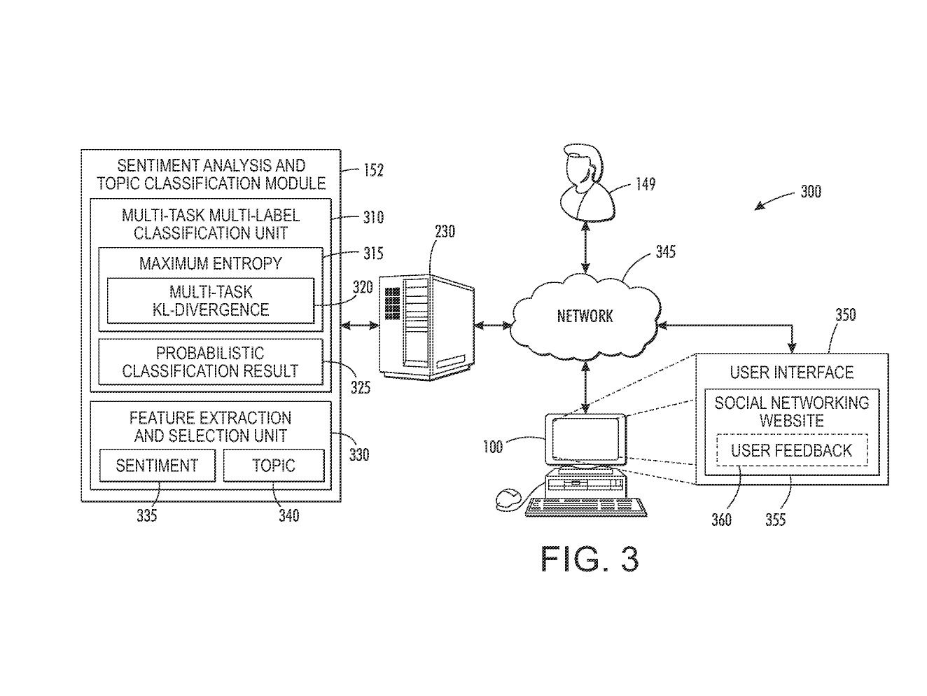

FIG. 3 illustrates a block diagram of sentiment analysis and topic classification system 300, in accordance with the disclosed embodiments. Note that in FIGS. 1-8, identical or similar blocks are generally indicated by identical reference numerals. Sentiment analysis and topic classification employs automated tools to detect subjective information such as opinions, attitudes, and feelings expressed in text. The sentiment analysis and topic classification system 300 generally includes the sentimental and topic classification module 152 for simultaneous sentimental and topic classification with multiple labels. The sentimental and topic classification module 152 further includes a multi-task multi-label classification unit 310 and a feature extraction and selection unit 330 connected to the data processing apparatus 100 via a network 345. The feature extraction and selection unit 330 performs feature extraction and selection on both tasks of sentiment and topic classification.

The multi-task multi-label classification unit 310 classifies a sentiment 335 and a topic 340 associated with a post 360 on a social networking website 355 at similar time and incorporates a result to predict a feature and a label of the two tasks. The social networking website 355 can be displayed on a user interface 350 associated with the data processing apparatus 100. The multi-task multi-label classification unit 310 trains a model for each task with maximum entropy 315 utilizing multiple labels to learn more information from an extra label and to deal with a class ambiguity. The principle of maximum entropy states that, subject to precisely stated prior data (such as a proposition that expresses testable information), the probability distribution which best represents the current state of knowledge is the one with largest information-theoretical entropy.

Note that the network 345 may employ any network topology, transmission medium, or network protocol. The network 345 may include connections such as wire, wireless communication links, or fiber optic cables. Network 345 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational and other computer systems that route data and messages.

The feature extraction and selection unit 330 generates predicting features and conducts feature selection to optimize the performance and to train the multi-task multi-label classification unit 310. The feature extraction and selection unit 330 removes stopping words and extracts all meaningful keywords and bi-grams for a collection of messages. The feature extraction and selection unit 330 chooses different numbers of predicting features from the keywords and bi-grams and trains the model with them and evaluates accuracy accordingly. Finally, the feature extraction and selection unit 330 determines number of predicting features as the one that the model produces the best accuracy with.

The feature extraction and selection unit 310 performs feature extraction and selection on both tasks of sentiment and topic classification. For each task, predicting features can be selected independently from the other task. The number of the optimal predicting features may vary for different tasks. Each task has a separate classification model with different predicting features and they can be trained collectively which allows flexibility in model construction. The multi-task multi-label classification unit 310 integrates the labels of one task as predicting variables into a feature vector of another task. The multi-task multi-label classification unit 310 estimates coefficient utilizing multi-task KL-divergence 320 based on prior distribution of the labels to incorporate multi-label.

In probability theory and information theory, the Kullback-Leibler divergence (also information divergence, information gain, relative entropy, or KLIC) is a non-symmetric measure of the difference between two probability distributions P and Q. Specifically, the Kullback-Lebler divergence of Q from P, denoted DKL(P∥Q), is a measure of the information lost when Q is used to approximate P; KL measures the expected number of extra bits required to code samples from P when using a code based on Q rather than using a code based on P. Typically P represents the “true” distribution of data, observations, or a precisely calculated theoretical distribution. The measure Q typically represents a theory, model, description, or approximation of P.

With predicting features extracted, each message can be mapped into a feature vector and each instance is associated with a set of class labels. For example, assume there are totally K classes and N training instances. Let Xi denote the feature vector of the i-th instance xi, where i=1, 2, . . . , N, and Li denotes its label set. The maximum entropy 315 can be employed to estimate the class distribution, which allows flexibility in model construction and also produces probabilistic classification result 325. Let θk represent the coefficient vector of the k-th class, k=1, 2, . . . , K and Yi represent the class that instance xi is assigned, then the probability of xi to be classified into the k-th class can be written as follows:

$$P ( {Y}_{i} = k \vert {X}_{i} , θ ) = \frac{{e}^{{θ}_{k} \cdot {X}_{i}}}{1 + {\sum }_{j = 1}^{K} {e}^{{θ}_{j} \cdot {X}_{i}}} \qquad ( 1 )$$

When solving multi-task classification, independence of each task cannot be assumed. By extending equation (1), classification labels of another task can be incorporated to make use of latent task associations. Given instance xi, assume LSi represents its sentiment labels and LTi represents its topic labels, then the feature vectors can be extended by including labels of another task. With multi-task extension, let xsi represent the sentiment feature vector and XSi be the extended one, then XSi=[xsi, LTi]. Similarly, xti and XTi can be employed to denote the initial and extended topic feature vector, XTi=[xti, LSi]. Based on them, let Ps and Pt denote the sentiment and topic distribution of an instance. Then the sentiment classification can be represented as shown below in equation (2):

$${P}_{s} ( {Y}_{i} = k \vert {xs}_{i} , {LT}_{i} , θ s ) = \frac{{e}^{θ {s}_{k} \cdot {XS}_{i}}}{1 + {\sum }_{j = 1}^{K} {e}^{θ {s}_{j} \cdot {XS}_{i}}} \qquad ( 2 )$$

The topic classification can be represented as shown below in equation (3):

$${P}_{t} ( {Y}_{i} = k \vert {xt}_{i} , {LS}_{i} , θ t ) = \frac{{e}^{θ {t}_{k} \cdot {XT}_{i}}}{1 + {\sum }_{j = 1}^{K} {e}^{θ {t}_{j} \cdot {XT}_{i}}} \qquad ( 3 )$$

As multi-label can be incorporated into the classification, the parameters θs and θt that can maximize the probability of instance xi to be labeled with LSi and Lti can be determined. Formally, let θ denote the optimal values of (θs, θt), the objective function to estimate parameters can be written as follows:

$$Θ = arg {max}_{θ s , θ t} {\prod }_{i}^{ } {P}_{s} ( {Y}_{i} ∈ {LS}_{i} \vert {xs}_{i} , {LT}_{i} , θ s ) \cdot {P}_{t} ( {Y}_{i} ∈ {LT}_{i} \vert {xt}_{i} , {LS}_{i} , θ t ) \qquad ( 4 )$$

Let \hat{P}ₛ and \hat{P}ₜ be the prior probability generated from the labels, then Ps and Pt are the posterior probability produced by the classification model. To estimate parameters, one approach is to make the model based classification match the distribution from prior labels as much as possible, i.e., minimize the difference between them. For each instance xi, \hat{P}ₛ_{ᵢ} can be calculated by the proportion of each label in LSi out of all labels in LSi and similarly for \hat{P}ᵣ_{ᵢ}. With constraints of probabilities, Σ_{kεLS}_{ᵢ}\hat{P}ₛ_{ᵢ}(Y=k|xᵢ)=1 and Σ_{kεLT}_{ᵢ}\hat{P}ₜ_{ᵢ}(Y=k|xᵢ)=1.

Based on equation (4), a widely accepted method of parameter estimation is to minimize the KL-divergence 320 between the prior and posterior probabilities of each instance. Denote S as all sentiment classes and T as all topic classes, following the KL-divergence 320, the objective function can be furthermore written as:

$$Θ = arg {min}_{θ s , θ t} \{ \begin{matrix}{\sum }_{i}^{ } {\sum }_{k ∈ S}^{ } {\hat{P}}_{{s}_{i}} ( Y = k \vert {x}_{i} ) log \frac{{\hat{P}}_{{s}_{i}} ( Y = k \vert {x}_{i} )}{{P}_{{s}_{i}} ( Y = k \vert {xs}_{i} , {LT}_{i} , θ s )} \\ {\sum }_{i}^{ } {\sum }_{k ∈ T}^{ } {\hat{P}}_{{t}_{i}} ( Y = k \vert {x}_{i} ) log \frac{{\hat{P}}_{{t}_{i}} ( Y = k \vert {x}_{i} )}{{P}_{{t}_{i}} ( Y = k \vert {xt}_{i} , {LS}_{i} , θ t )}\end{matrix} \qquad ( 5 )$$

Since for any class k that is not in LS or LT, the prior probability is \hat{P}ₛ_{ᵢ}(Y=k|xᵢ)=\hat{P}ₜ_{ᵢ}(Y=k|xᵢ)=0, which means that they do not have influence on the parameter estimation. Therefore, equation (5) can be simplified to the following:

$$Θ = arg {max}_{θ s , θ t} \{ \begin{matrix}{\sum }_{i}^{ } {\sum }_{k ∈ {LS}_{i}}^{ } & {\hat{P}}_{{s}_{i}} ( Y = k \vert {x}_{i} ) \cdot log {P}_{{s}_{i}} ( Y = k \vert {xs}_{i} , {LT}_{i} , θ s ) \\ {\sum }_{i}^{ } {\sum }_{k ∈ {LT}_{i}}^{ } & {\hat{P}}_{{t}_{i}} ( Y = k \vert {x}_{i} ) \cdot log {P}_{{t}_{i}} ( Y = k \vert {xt}_{i} , {LS}_{i} , θ t )\end{matrix} \qquad ( 6 )$$

with constraints Σ_{kεLS}_{ᵢ}\hat{P}ₛ_{ᵢ}(Y=k|xᵢ)=1 and Σ_{kεLT}_{ᵢ}\hat{P}ₜ_{ᵢ}(Y=k|xᵢ)=1. In equation (6), Psi and Pti represents model-based probabilities, which vary with θs and θt. By solving equation (6), θs and θt can be determined. When the data is sparse, ME may have the problem of over fitting. To reduce over fitting, a Gaussian can be integrated prior into ME for parameter estimation, with mean at 0 and variance of 1. The sentiment and topic classes can be determined by equation (2) and (3) for given post and the feature vector after the model is trained. Since extended feature vectors of the two tasks make use of labels from each other, it is necessary to obtain the initial labels. They can be generated from the classic ME model or any other classification approach. After that, during the process of multi-task classification, the sentiment labels obtained from equation (2) can be applied in equation (3) for topic classification, and vice versa. The classification results can be updated until converges by repeating the two tasks iteratively.

FIG. 4 illustrates a high level flow chart of operations illustrating logical operational steps of a method 400 for simultaneous sentiment analysis and topic classification with multiple labels, in accordance with the disclosed embodiments. It can be appreciated that the logical operational steps shown in FIG. 4 can be implemented or provided via, for example, a module such as module 154 shown in FIG. 2 and can be processed via a processor such as, for example, the processor 101 shown in FIG. 1. Initially, as indicated at block 410, the sentiment 335 and topic 340 associated with a post can be classified at similar time and a result can be incorporated to predict a feature and a label of the two tasks. The feature extraction and selection can be performed on both tasks of sentiment and topic classification, as illustrated at block 420.

The model can be trained for each task with maximum entropy 315 utilizing multiple labels to learn more information from an extra label and to deal with a class ambiguity, as shown at block 430. Each task has a separate classification model with different predicting features and they can be trained collectively which allows flexibility in model construction, as depicted at block 440. The labels of one task can be integrated as predicting variables into a feature vector of another task, as illustrated at block 450. The coefficient can be estimated utilizing multi-task KL-divergence 320 based on prior distribution of the labels to incorporate multi-label, as indicated at block 460. The multi-task multi-label (MTML) classification model produces the probabilistic result 325 and the classes can be ranked by the probabilities and the post can be classified with multi-label, as depicted at block 470.

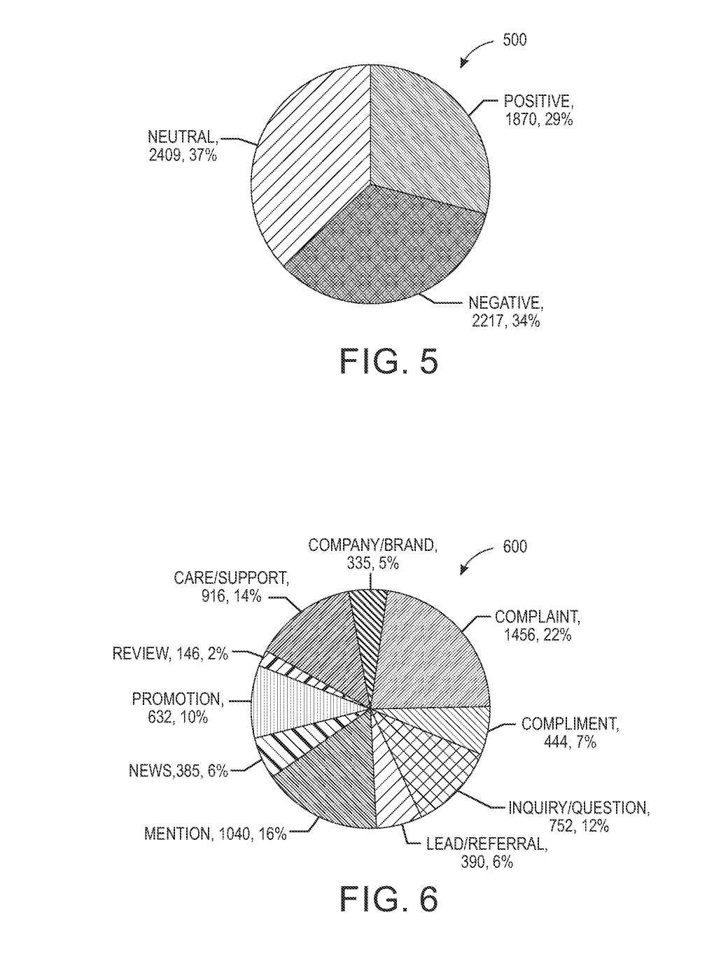

FIGS. 5-6 illustrate a graph depicting distribution of sentimental classes 500 and topic classes 600, in accordance with the disclosed embodiments. For example, the multi-task multi-label classification module 152 can be evaluated on a set of messages having at least one of the keywords “virginmobile”, “VMUcare”, “boostmobile”, and “boostcare”. The sentiments and topics of messages that come from users of Boost mobile and Virgin mobile can be classified. A collection of totally 6496 user-generated messages can be collected for the experiment after removing messages that are generated by company customer services. For classification, 3 sentiment classes and 10 topic classes can be selected, which are preset by professionals from the companies. The sentiment classes are “positive”, “negative”, and “neutral”. FIG. 5 shows the number of messages in each class and their percentage. Topic classes include “care/support”, “lead/referral”, “mention”, “promotion”, “review”, “complaint”, “inquiry/question”, “compliment”, “news”, and “company/brand”. The number of messages in each class and their percentages are shown in FIG. 6.

The sentiment labels and topic labels of messages can be assigned by human experts from Amazon Mechanical Turk (AMT). AMT is a crowdsourcing marketplace which allows collaboration of people to complete tasks that are hard for computers. AMT has two types of users: requesters and workers. Requesters post Human Intelligence Tasks (HITs) and offer a small payment, while workers can browse HITs and complete them to get payment. Requesters may accept or reject the result sent by workers. With certain quality control mechanisms, requesters can obtain high-quality results of HITS through AMT. From AMT, 3 labels for each message of each task can be obtained. Labels may be identical or different. For each message, if two or more labels agree with each other, then this majority-voting label can be selected as the ground truth. When all 3 labels are different, one of them is randomly picked up as ground truth. Out of all messages, 6143 of them have majority-voting sentiment labels and 4466 have majority-voting topic labels. Among 4257 messages with both sentiment and topic majority-voting labels, 500 can be selected for testing. The left 5996 messages are used for training.

The classification models, for example, Naive Bayes (NB), Maximum Entropy (ME), Support Vector Machine (SVM), EM with Prior on Maximum Entropy can be employed to validate the model. First, MTML can be compared against the baseline models on both tasks. After that, LP with DMI can be applied to convert the multi-task multi-label classification into single-task single-label classification and then the performance of baselines can be measured accordingly. The features can be predicted by extracting keywords from message contents. Initially 50553 keywords are extracted. The feature selection can be conducted by evaluating the predicting accuracy of NB, ME, and SVM. In the process, their accuracy can be measured while the number of features varies from 400 to 5000. For sentiment classification, the highest accuracy can be obtained with 3400 features. For topic task, 2800 features produce the best result. As a result, in the experiment, 3400 and 2800 features can be adopted for sentiment and topic classification, respectively.

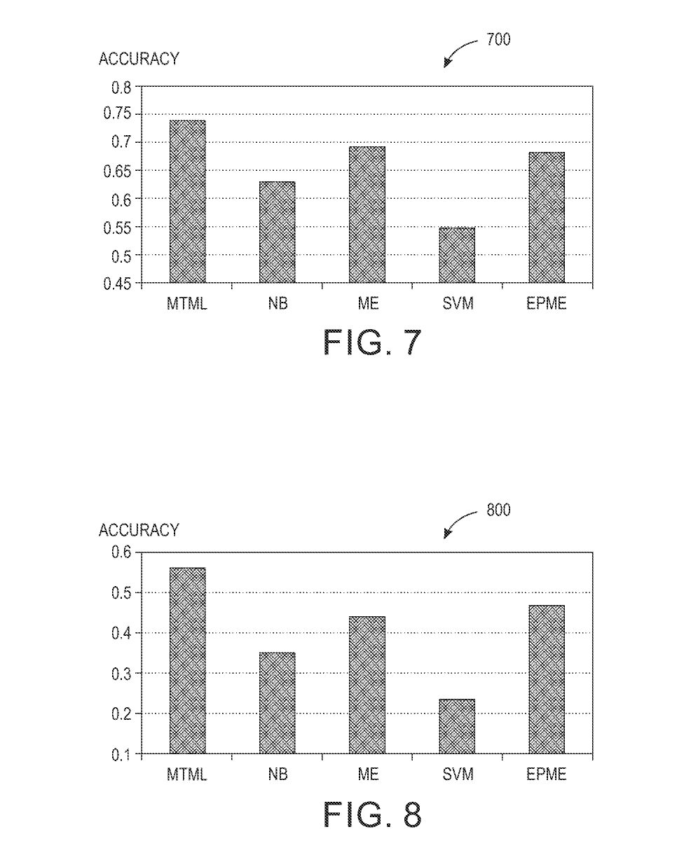

FIGS. 7-8 illustrate a graph depicting distribution of sentiment and topic classification accuracy of MTML model 700 and baselines 800, in accordance with the disclosed embodiments. The MTML can be evaluated on both sentiment classification and topic classification. The results of MTML can be compared against baselines respectively. The MTML model can be measured on sentiment classification. The training dataset contains 5996 messages and the testing data contains 500 messages. Each training message can be associated with 3 training labels. Meanwhile, MTML can be evaluated against NB, ME, SVM, and EPME. FIG. 7 shows the accuracy of MTML and baselines on sentiment classification. In testing, MTML makes an accuracy of 74.4%. As shown in the table, MTML outperforms all baselines, the performance of which is all below 70%.

Second, the MTML model can be validated with topic classification on similar dataset. Classification accuracies of the model and baselines are shown in FIG. 8. Since there are totally 10 topic classes and their distribution is not even, the accuracies of both MTML and baselines are not very high. However, MTML still outperforms the baselines and achieves an accuracy of 55.8%. All baselines obtain less than 50% accuracy. Such multi-task multi-label (MTML) classification module 152 produces a probabilistic result 325 and the classes can be ranked by the probabilities and the post can be classified with multi-label. The system 300 permits flexible multi-label classification in multiple tasks as predicting labels to be associated with weights.

Based on the foregoing, it can be appreciated that a number of embodiments, preferred and alternative, are disclosed herein. For example, in one embodiment, a method is disclosed for simultaneous sentiment analysis and topic classification. Such a method can include the steps or logical operations of, for example, classifying a sentiment and a topic associated with a post simultaneously to thereafter incorporate a result thereof for use in predicting a feature so that a label associated with two or more tasks is capable of promoting and reinforcing each other iteratively; performing a feature extraction and selection with respect to the two or more tasks for training a multi-task multi-label classification model for each of the two or more tasks with a maximum entropy utilizing the label to derive data from an extra label and to deal with class ambiguities; and generating a probabilistic result via the multi-task multi-label classification model so as to thereafter rank the class according to the probabilistic result.

In another embodiment, a step or logical operation can be provided for collectively training each of the two or more tasks via a separate classification model having differing predicting features. In still other embodiments, steps or logical operations can be provided for integrating the label of one task among the two or more tasks as a predicting variable into a feature vector of another task among the two or more tasks; and estimating a coefficient utilizing a multi-task KL-divergence based on a prior distribution of the label to incorporate a multi-label.

In yet another embodiment, a step or logical operation can be implemented for classifying the post with the multi-label. In other embodiments, steps or logical operations can be provided for removing a stopping word; extracting a keyword and a bi-gram for a plurality of messages; selecting the differing predicting features from the keyword and the bi-gram; and training and evaluating the multi-task multi-label classification model with the predicting features to thereafter determine a number of optimal predicting features thereof.

In another embodiment, a step or logical operation can be implemented for independently selecting the differing predicting features for each of the at least one tasks from at least one other task wherein differing predicting features vary with respect to different tasks. In still another embodiment, a step or logical operation can be provided for simulating the distribution of the sentiment and the topic via a maximum entropy based multi-task classification model.

In another embodiment, a system for simultaneous sentiment analysis and topic classification can be implemented. Such a system can include, for example, a processor and a data bus coupled to the processor. Such a system can further include, for example, a computer-usable medium embodying computer program code, the computer-usable medium being coupled to the data bus. The aforementioned computer program code can include instructions executable by the processor and configured for, for example, classifying a sentiment and a topic associated with a post simultaneously to thereafter incorporate a result thereof for use in predicting a feature so that a label associated with two or more tasks is capable of promoting and reinforcing each other iteratively; performing a feature extraction and selection with respect to the two or more tasks for training a multi-task multi-label classification model for each of the two or more tasks with a maximum entropy utilizing the label to derive data from an extra label and to deal with class ambiguities; and generating a probabilistic result via the multi-task multi-label classification model so as to thereafter rank the class according to the probabilistic result.

In another embodiment, such instructions can be further configured for collectively training each of the two or more tasks via a separate classification model having differing predicting features. In other embodiments, such instructions can be further configured for integrating the label of one task among the two or more tasks as a predicting variable into a feature vector of another task among the two or more tasks; and estimating a coefficient utilizing a multi-task KL-divergence based on a prior distribution of the label to incorporate a multi-label. In yet another embodiment, such instructions can be further configured for classifying the post with the multi-label.

In still another embodiment, such instructions can be further configured for removing a stopping word; extracting a keyword and a bi-gram for a plurality of messages; selecting the differing predicting features from the keyword and the bi-gram; and training and evaluating the multi-task multi-label classification model with the predicting features to thereafter determine a number of optimal predicting features thereof.

In yet another embodiment, such instructions can be further configured for independently selecting the differing predicting features for each of the at least one tasks from at least one other task wherein differing predicting features vary with respect to different tasks. In another embodiment, such instructions can be further configured for simulating a distribution of the sentiment and the topic via a maximum entropy based multi-task classification model.

In another embodiment, processor-readable medium storing code representing instructions to cause a process for simultaneous sentiment analysis and top classification can be provided. Such code can include code to, for example, classify a sentiment and a topic associated with a post simultaneously to thereafter incorporate a result thereof for use in predicting a feature so that a label associated with two or more tasks is capable of promoting and reinforcing each other iteratively; extract and select a feature with respect to the two or more tasks for training a multi-task multi-label classification model for each of the two or more tasks with a maximum entropy utilizing the label to derive data from an extra label and to deal with class ambiguities; and generate a probabilistic result via the multi-task multi-label classification model so as to thereafter rank the class according to the probabilistic result.

In other embodiments, such code can further include code to collectively train each of the two or more tasks via a separate classification model having differing predicting features. In another embodiment, such code can include code to integrate the label of one task among the two or more tasks as a predicting variable into a feature vector of another task among the two or more tasks; and estimate a coefficient utilizing a multi-task KL-divergence based on a prior distribution of the label to incorporate a multi-label. In still other embodiments, such code can further include code to classify the post with the multi-label.

In yet other embodiments, such code can further include code to remove a stopping word; extract a keyword and a bi-gram for a plurality of messages; select the differing predicting features from the keyword and the bi-gram; and train and evaluate the multi-task multi-label classification model with the predicting features to thereafter determine a number of optimal predicting features thereof. In still other embodiments, such code can further include code to independently select the differing predicting features for each of the at least one tasks from at least one other task wherein differing predicting features vary with respect to different tasks.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. A method for simultaneous sentiment analysis and topic classification, said method comprising:
classifying a sentiment and a topic associated with a post simultaneously to thereafter incorporate a result thereof for use in predicting a feature so that a label associated with at least two tasks is capable of promoting and reinforcing each other iteratively;
performing a feature extraction and selection with respect to said at least two tasks for training a multi-task multi-label classification model for each of said at least two tasks with a maximum entropy utilizing said label to derive data from an extra label and to deal with class ambiguities; and
generating a probabilistic result via said multi-task multi-label classification model so as to thereafter rank said class according to said probabilistic result.

2. The method of claim 1 further comprising collectively training each of said at least two tasks via a separate classification model having differing predicting features.

3. The method of claim 1 further comprising:
integrating said label of one task among said at least two tasks as a predicting variable into a feature vector of another task among said at least two tasks; and
estimating a coefficient utilizing a multi-task KL-divergence based on a prior distribution of said label to incorporate a multi-label

4. The method of claim 3 further comprising classifying said post with said multi-label.

5. The method of claim 2 further comprising:
removing a stopping word;
extracting a keyword and a hi-gram for a plurality of messages;
selecting said differing predicting features from said keyword and said bi-gram; and
training and evaluating said multi-task multi-label classification model with said predicting features to thereafter determine a number of optimal predicting features thereof.

6. The method of claim 1 further comprising independently selecting said differing predicting features for each of said at least one tasks from at least one other task wherein differing predicting features vary with respect to different tasks.

7. The method of claim 1 further comprising simulating a distribution of said sentiment and said topic via a maximum entropy based multi-task classification model.

8. A system for simultaneous sentiment analysis and topic classification, said system comprising:
a processor;
a data bus coupled to said processor; and
a computer-usable medium embodying computer program code, said computer-usable medium being coupled to said data bus, said computer program code comprising instructions executable by said processor and configured for:
classifying a sentiment and a topic associated with a post simultaneously to thereafter incorporate a result thereof for use in predicting a feature so that a label associated with at least two tasks is capable of promoting and reinforcing each other iteratively;
performing a feature extraction and selection with respect to said at least two tasks for training a multi-task multi-label classification model for each of said at least two tasks with a maximum entropy utilizing said label to derive data from an extra label and to deal with class ambiguities; and
generating a probabilistic result via said multi-task multi-label classification model so as to thereafter rank said class according to said probabilistic result.

9. The system of claim 8 wherein said instructions are further configured for collectively training each of said at least two tasks via a separate classification model having differing predicting features.

10. The system of claim 8 wherein said instructions are further configured for:
integrating said label of one task among said at least two tasks as a predicting variable into a feature vector of another task among said at least two tasks; and
estimating a coefficient utilizing a multi-task KL-divergence based on a prior distribution of said label to incorporate a multi-label

11. The system of claim 10 wherein said instructions are further configured for classifying said post with said multi-label.

12. The system of claim 9 wherein said instructions are further configured for:
removing a stopping word;
extracting a keyword and a bi-gram for a plurality of messages;
selecting said differing predicting features from said keyword and said bi-gram; and
training and evaluating said multi-task multi-label classification model with said predicting features to thereafter determine a number of optimal predicting features thereof.

13. The system of claim 8 wherein said instructions are further configured for independently selecting said differing predicting features for each of said at least one tasks from at least one other task wherein differing predicting features vary with respect to different tasks.

14. The system of claim 8 wherein said instructions are further configured for simulating a distribution of said sentiment and said topic via a maximum entropy based multi-task classification model.

15. A processor-readable medium storing code representing instructions to cause a process for simultaneous sentiment analysis and top classification, said code comprising code to:
classify a sentiment and a topic associated with a post simultaneously to thereafter incorporate a result thereof for use in predicting a feature so that a label associated with at least two tasks is capable of promoting and reinforcing each other iteratively;
extract and select a feature with respect to said at least two tasks for training a multi-task multi-label classification model for each of said at least two tasks with a maximum entropy utilizing said label to derive data from an extra label and to deal with class ambiguities; and
generate a probabilistic result via said multi-task multi-label classification model so as to thereafter rank said class according to said probabilistic result.

16. The processor-readable medium of claim 15 wherein said code further comprises code to collectively train each of said at least two tasks via a separate classification model having differing predicting features.

17. The processor-readable medium of claim 15 wherein said code further comprises code to:
integrate said label of one task among said at least two tasks as a predicting variable into a feature vector of another task among said at least two tasks; and
estimate a coefficient utilizing a multi-task KL-divergence based on a prior distribution of said label to incorporate a multi-label

18. The processor-readable medium of claim 17 wherein said code further comprises code to classify said post with said multi-label.

19. The processor-readable medium of claim 16 wherein said code further comprises code to:
remove a stopping word;
extract a keyword and a bi-gram for a plurality of messages;
select said differing predicting features from said keyword and said bi-gram; and
train and evaluate said multi-task multi-label classification model with said predicting features to thereafter determine a number of optimal predicting features thereof.

20. The processor-readable medium of claim 15 wherein said code further comprises code to independently select said differing predicting features for each of said at least one tasks from at least one other task wherein differing predicting features vary with respect to different tasks.
